(19) United States
(12) Patent Application Publication
(10) Pub. No.: US 2014/0116351 A1
(43) Pub. Date: May 1, 2014

(54) DOG WASHING COVER

(71) Applicant: GARY MANSELL, (US)

(72) Inventor: GARY MANSELL, NORTH SALT LAKE, UT (US)

(73) Assignee: GARY MANSELL, NORTH SALT LAKE, UT (US)

(21) Appl. No.: 13/663,704

(22) Filed: Oct. 30, 2012

(51) Int. Cl. A01K 13/00; A01K 29/00

(52) U.S. Cl. 119/650

(57) ABSTRACT

A dog washing cover made from clear water resistance material that allows a dog washer to wash a dog while minimal mess. The dog washing cover allows the dog washer to access the dog to bath the dog but prevents water from soiling the dog washer or the surrounding area.

### BACKGROUND OF THE INVENTION

To bath a dog, the dog is generally placed in a bathtub and washed. Spray hoses are generally used to wet the dog and to rinse soap from the dog. Overspray from the spray hoses and a dogs tendency to shake water off when wet causes dirty soapy water to scatter outside the bathing area soiling a large area. This requires additional time to be spent on cleanup after the dog has been bathed. This is especially true when bathing the dog indoors.

To solve this problem a dog washing cover can be used that will prevent water, dirt and mud from soiling the room where the dog is being washed. The cover will allow the dog washer access to the dog to wash the dog while preventing unwanted splashing.

### SUMMARY OF THE INVENTION

Embodiments of an apparatus are also described. In one embodiment, the apparatus is a dog washing cover comprising a clear plastic sheet made of water resistant material Additionally, the dog washing cover has a first access hole on a first side of the sheet and second access hole on a second side of the sheet. A first flap is used to cover the first access hole and second flap is used to cover the second hole wherein the first flap and the second flap are configured to allow access to the holes. further there is a top access hole in the middle of the sheet.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 depicts a dog washing cover.

FIG. 2 depicts a dog washing cover on a dog.

Throughout the description, similar reference numbers may be used to identify similar elements.

### DETAILED DESCRIPTION

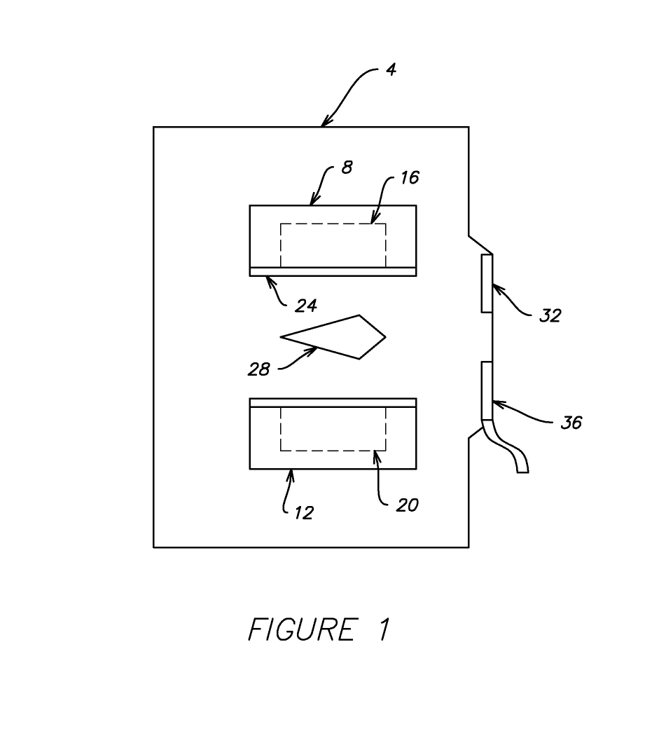

FIG. 1 depicts a dog washing cover. Dog washing cover 4 has flaps 8 and 12. Side access holes 16 and 20 are covered by flaps 8 and 12. Strip 24 is used to attached flaps 8 and 12 to dog washing cover 4. Top access hole 28 is located in the middle of the dog washing cover. Velcro hooks 32 are attached to dog washing cover 4 and can be connected to Velcro loops 36. Velcro loops 36 are attached to dog washing cover 4.

Dog washing cover 4 can be made of any material that is clear and water resistant. In one embodiment Dog washing cover 4, flap, 8 and flap 12 are made from clear vinyl. Flaps 8 and 12 are attached to dog washing cover 4 by sewing through strip 24. The strip 24 reinforces the flap connection. Velcro hooks 32 and Velcro loops 36 are sewn onto dog washing cover 4. Dog washing cover 4 can be sized to any dimensions needed to based on the size of dog to be bathed. In one embodiment dog washing cover 4 is four feet long and three feet wide.

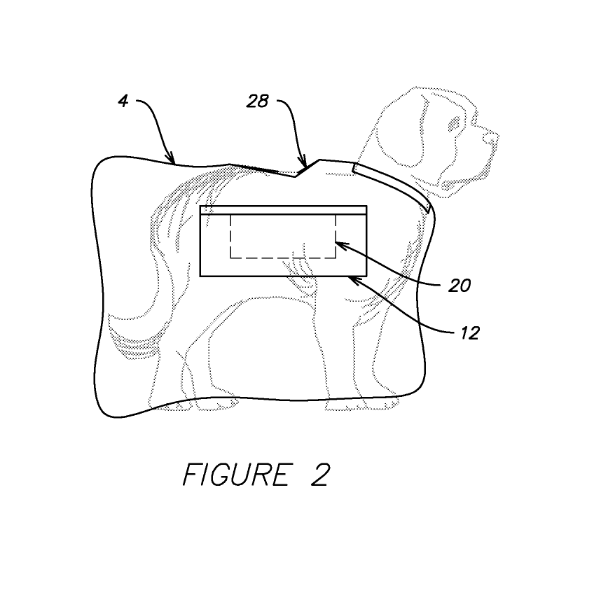

FIG. 2 depicts a dog washing cover on a dog. The dog washer can access the dog through top access hole 28 and side access holes 16 and 20. Spray hoses and soap and be applied to the dog through the openings. The dog washer can use their hands to scrub the dog while the protective dog washing cover 4 prevents water from getting the dog washer wet. All of the water flows down the side of the dog washing cover 4 onto the floor. The Velcro strap is used to secure the dog washing cover 4 around the dog and can be adjusted based on the dogs neck size. The dog washing cover 4 is configured to cover a back portion of the dogs neck. After the dog has been washed the dog can be dried with the dog washing cover 4 still in place. This prevents the dog from shaking off the water and soiling the room.

Dog washing cover 4 allows a dog washer to wash a dog indoors in a bathroom without having the bathroom walls dirtied. This makes washing a dog much more convenient when it is not possible to wash a dog outside. A dog can be placed in a bath where all of the water will flow down the drain and not get outside the tub or one the walls. The dog washing cover 4 is lightweight and can folded and stored easily.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Although specific embodiments of the invention have been described and illustrated, the invention is not to be limited to the specific forms or arrangements of parts so described and illustrated. The scope of the invention is to be defined by the claims appended hereto and their equivalents.

1. A dog washing cover comprising:
a clear plastic sheet made of water resistant material wherein the sheet is configured to be open on the bottom when the sheet is placed over an animal such that when water is placed under the sheet onto the animal it flows out the open bottom away from the animal and;
a first access hole on a first side of the sheet and second access hole on a second side of the sheet wherein the first hole and the second hole are positioned such that when the sheet is draped over the animal the first hole and the second hole allow access to opposite sides of the animal and the first hole and the second hole are sized to allow a hand to pass through;
a first flap covering the first access hole and second flap covering the second hole wherein the first flap and the second flap are configured to allow access to the first access hold and second access hole; and
a top access hole in the middle of the sheet.

2. The dog washing cover of claim 1 wherein the sheet is sized to cover a dog.

3. The dog washing cover of claim 1 wherein the sheet is made of clear vinyl.

4. The dog washing cover of claim 1 further comprising a hook and loop fastener fabric strap used to secure the sheet around a dog.

5. (canceled)
